(19) United States
(12) Patent Application Publication
(10) Pub. No.: US 2023/0389521 A1
(43) Pub. Date: Dec. 7, 2023

(54) Animal Treat Dispenser and Training Device for Controllable Delivery of Lickable Treat

(71) Applicant: Sara Peterson, Bethesda, MD (US)

(72) Inventor: Sara Peterson, Bethesda, MD (US)

(21) Appl. No.: 18/328,245

(22) Filed: Jun. 2, 2023

Related U.S. Application Data
(60) Provisional application No. 63/438,376, filed on Jan. 11, 2023.
(60) Provisional application No. 63/348,490, filed on Jun. 3, 2022.

(51) Int. Cl. A01K 15/02

(52) U.S. Cl. CPC A01K 15/025

(57) ABSTRACT

A pet reward and training device comprising a body in which a lickable treat might be stored and a semi-removable dispensing mechanism is disclosed. An example reward and training device includes a flexible body used to store a pliable treat substance attached to a flip-top cap through which a lickable edible treat might be continuously dispensed by squeezing or otherwise manipulating the flexible body containing the treat substance. Example devices may include additional features such as ‘clickers’ or other noisemakers, loops or handles, or storage-related elements.

### CROSS-REFERENCE TO RELATED APPLICATIONS

63/348,490, 63/438,376

### BACKGROUND OF INVENTION

Positive reinforcement training methods, wherein animals are rewarded for desired or requested (“good”) behavior, have long been recognized as among the most effective means of training. These kinds of positive reinforcement training methods often employ edible treats as rewards and incentives to help encourage wanted or desirable behaviors or outcomes (e.g., housebreaking, learning tricks and commands, etc.). The efficacy of treat-based training to encourage wanted behaviors relies on the strength of the association between the desired behavior and the reward (i.e., the edible treat); delays between the completion of the desirable behavior and the distribution of the edible treat can diminish the efficacy of training.

Edible treats are also often used to help deter unwanted behaviors (e.g., barking, growling, lunging, snapping, etc.) by helping redirect an animal's attention away from negative stimuli (e.g., other animals) and towards the trainer, owner, or individual in control of the treat. As a result, the use of edible treats as a deterrent may be particularly helpful for individuals training fearful or reactive animals that may be especially prone to these kinds of negative behaviors. Edible treats that are lickable in nature are often particularly effective in this kind of training, and the continuous distribution of these treats (e.g., dispensed through an opening such as a hole, valve, or nozzle) may give the owner or trainer additional control over the animal's behavior, as the dispensing container can be used to gently adjust the animal's position while providing an uninterrupted distribution of the treat contained therein.

Given the prevalence and value of edible treats in animal training regimes, there is value in the development of treat dispensers and training devices that are portable, convenient, easy to store, and easy to use in a variety of contexts and conditions, including while outside or on the go). In particular, there is value in the development of treat dispensers and training devices that may be held and operated with a single hand, leaving the other hand free to maintain control over the animal's movement and behavior.

### SUMMARY OF INVENTION

An animal reward and training device containing a storage compartment housing a lickable treat (e.g., a paste, gel, solid, or semi-solid treat), and a semi-removable component by which the lickable treat might be exposed, dispensed, and re-covered (or sealed) is disclosed. The animal reward and training device includes a proximal and a distal end. The distal end of the device includes a storage compartment in which a lickable treat may be housed and from which the lickable treat may be dispensed to the animal. The proximal end of the device may include one or more openings enclosed by at least one semi-removable dispensing mechanism (e.g., a flip-top cap, a retractable lid, a rotating, sliding, swivel, lever-based or toggle-based opening, etc.). The animal reward and training device in this disclosure is configured to enable (most) users to comfortably hold and operate the device (i.e., open the semi-removable dispensing mechanism of the device, dispense the lickable treat to the pet in a controlled manner, and close the semi-removable dispensing mechanism of the device) using a single hand.

### BRIEF DESCRIPTION OF THE FIGURES

FIG. 1 shows a side-profile view of a first example embodiment of the pet reward and training device

FIG. 2 shows an exploded front-profile view of the first example embodiment of the pet reward and training device that was first introduced in FIG. 2

FIG. 3 shows a front-perspective view of a second example embodiment of the pet reward and training device

FIG. 4 shows a side-profile view of the second example embodiment of the pet reward and training device that was first introduced in FIG. 3

FIG. 5 shows an exploded side-profile view of the second example embodiment of the pet reward and training device that was first introduced in FIG. 3

FIG. 6 shows an angled perspective of a third example embodiment of the pet reward and training device

FIG. 7 shows an angled perspective of a fourth example embodiment of the pet reward and training device

FIG. 8 shows a side-profile view of the fourth example embodiment of the pet reward and training device that was first introduced in FIG. 7

### DETAILED DESCRIPTION OF THE INVENTION

The embodiments presented in this disclosure are intended to illustrate the key features of the training device. Accordingly, it is to be understood that the embodiments of the training device subsequently disclosed are illustrative of some potential embodiments of the device, and should not be taken as representative of all potential embodiments of this device.

An animal reward and training device containing a storage compartment housing a lickable treat (e.g., a paste, gel, solid, or semi-solid treat), and a semi-removable component by which the lickable treat might be exposed, dispensed, and re-covered (or sealed) is disclosed. The animal reward and training device in this disclosure is configured to enable (most) users to comfortably hold and operate the device (i.e., open the semi-removable dispensing mechanism of the device, dispense the lickable treat to the pet in a controlled manner, and close the semi-removable dispensing mechanism of the device) using a single hand.

The animal reward and training device may include a proximal and a distal end. The distal end of the device may comprise a storage compartment in which at least one lickable treat may be housed. In some preferred embodiments of the device, the materials comprising the housing for the lickable treat may include thermally-insulating materials. The distal end of the device may enable the lickable treat housed therein to be controllably extruded into the proximal end of the device and dispensed to the animal in a number of ways. In some embodiments of the device, the nature of the treat compartment itself may be such that the user might directly manipulate the treat compartment to extrude the lickable treat from the treat compartment (e.g., the treat compartment may comprise a flexible material such as silicone or rubber that may be squeezed, rolled, or otherwise manipulated to control the extrusion and dispensing of a pliable lickable treat). In such embodiments in which the treat chamber is flexible or partially flexible, the user may control the rate at which the treat is dispensed by exerting more or less force on the walls of the treat compartment. In some embodiments of the device, the treat compartment may include a mechanism (e.g., a lever-type mechanism or a screw-type mechanism) that may facilitate the extrusion of the lickable treat from the treat compartment so it might be dispensed to the animal. In such embodiments, the user may use said mechanism to control the rate at which the treat is dispensed to the animal.

The proximal end of the device may include at least one opening through which the lickable treat may be dispensed from the device. These opening(s) may be accompanied by a mechanism or structure by which the opening may be sealed (thus securely encasing the treat within the confines of the device) and unsealed (thus exposing the lickable treat enclosed in the device and enabling it to be dispensed) by the manipulation of associated structures or mechanisms that are here described as “semi-removable dispensing mechanisms”. These semi-removable dispensing mechanisms may include any kind of structure or mechanism that might be used to reliably open and shut the opening in the device without ever fully separating from the main structure of the device (potential semi-removable dispensing mechanisms might include, for example, flip-top caps or flip-top lids, retractable lids or tops, a rotating, sliding, swivel, or toggle-based openings).

In this disclosure, the term ‘semi-removable dispensing mechanism’ may be used to refer to structures or mechanisms in the device that might be used to seal and reseal openings in the device, or it may more generally be used to refer to said structures or mechanisms along with the openings with which they are associated.

The semi-removable dispensing mechanism(s) included in the device may be designed so as to be opened and closed using a single hand, thus enabling the user to use the other hand to control the animal in question. This attribute of the semi-removable dispensing mechanism, coupled with the ability to control the extrusion of the lickable treat from the treat compartment with a single hand, may enable the training device to be fully operated using a single hand.

The opening(s) through which the lickable treat is dispensed may vary in size. The preferred embodiment for, for example, less-viscous lickable substances may include smaller opening(s) through which the lickable substance might be dispensed, while the preferred embodiment for more-viscous substances may include larger opening(s) through which the lickable substance may be dispensed. Some embodiments of the device may include two or more openings on the proximal end of similar or various sizes that might be alternatively used according to user preference. Other embodiments of the device may include an opening that might be modified (e.g., made larger or smaller) based on user preference, while other embodiments of the device may include modular openings of various sizes and shapes that might be variously interchanged to meet user needs and preferences. Some embodiments of the device might include a one-way valve that could be embedded in the opening to help facilitate control over the dispensing of the lickable treat.

The lickable treat enclosed in the distal end of the device may be dispensed in a number of ways. In some embodiments of the device, the distal end of the device may include a mechanism facilitating the advancement of the lickable treat formulation for dispensing to animals (e.g., a lever-based mechanism or a screw-type mechanism). In other preferred embodiments of the device, the distal end of the device may be comprised, or partially comprised, of materials that directly enable the manual advancement and dispensing of the lickable treat without the need for additional advancement mechanisms (e.g., the storage compartment housing the lickable treat may comprise or partially comprise a flexible material that may be squeezed or otherwise manipulated to advance and dispense a lickable treat housed therein). In some embodiments, the storage compartment housing the lickable treat may comprise multiple layers, one or more of which may comprise or partially comprise a flexible material that may be manipulated to advance and dispense the lickable treat. In some preferred embodiments of the device, the materials comprising the housing for the lickable treat may include thermally-insulating materials that might be used to help keep the enclosed treat either warmer or cooler than the ambient temperature.

In some embodiments, the proximal and distal ends of the device may comprise a single component. In such embodiments, both the compartment in which the lickable treat is housed and the semi-removable dispensing component through which the lickable treat is dispensed might be included as part of a single component. In other embodiments, the device may comprise two or more separate components that may be securely and releasably connected. In some such embodiments, the distal component housing the lickable treat may be directly affixed to the proximal component including the semi-removable dispensing mechanism. In other such embodiments, the distal component housing the lickable treat may be indirectly affixed to the proximal component via one or more auxiliary components used to help secure the distal and proximal components of the device. The mechanisms used to either directly or indirectly affix the proximal component and the distal component of the device may include mechanisms that may enable the components to be slid together, threaded augers which may be screwed together, snap-shut doors or latches, clips, magnets, buckle-style mechanisms, or other structures used to securely and releasably affix the components.

In some embodiments of the device, one or more additional features or components may be affixed or integrated into the proximal or distal components of the device. These additional attributes may serve to facilitate or enhance the efficacy, functionality, ease of use, or otherwise increase the general attractiveness or desirability of the device in a variety of ways. In some embodiments of the device, a loop, hole, handle, strap, or any type of similar structure may be integrated or otherwise affixed or attached to the proximal or distal end of the device. These structures may vary greatly in size, nature, and placement. Some embodiments of the device may include a loop originating from the distal end of the device that might be large enough for users to slip over their wrists. Some embodiments of the device may include loop- or hole-style structures that are comparatively small or inobtrusive (e.g., a tab with a hole 0.25″ in diameter located at the distal end of the device). Some embodiments of the device may include loop- or hole-style structures such as a strap extending from the proximal to the distal end of the device that might help a user keep the device secure in the palm of their hand without needing to actively grasp the device with their fingers. Potential embodiments of the device may include two or more of these types of structures.

In some embodiments of the device, the proximal or distal end of the device may be modified to enable small items to be stored in or otherwise affixed to the training device. Potential features facilitating the storage or attachment of small items (e.g., household keys, waste bags, and other similar items) include netting, pockets, compartments, cavities, and other similar structures that may be incorporated or affixed to either the proximal or distal end of the device. Potential embodiments of the device may include any number of these types of storage-related structures, and these features may assume a wide variety of shapes and sizes. In some embodiments of the device, the proximal or distal components of the device may be modified to include an additional animal-related accessory, such as a small flashlight, a whistle, or a squeaker.

In some preferred embodiments of the device, one or more noisemaker components (e.g., a clicker device used to produce ‘clicking’ sounds that are frequently used as part of positive reinforcement training techniques) may be integrated into the device. The noisemaker may be incorporated into the device in a variety of ways. Some potential embodiments incorporating noisemaker components may include a noisemaker directly housed in the proximal component encompassing the semi-removable dispensing mechanism, a noisemaker housed in an auxiliary component used to affix the distal and proximal components of the device, or a noisemaker integrated into the distal component of the device. One preferred embodiment of the device may include the integration of the clicker in the proximal end of the device, thus facilitating the ease with which the user might use the clicker component in their training techniques.

Some potential embodiments of the device may include two or more bodies in which to house lickable treats, which may be dispensed via one or more semi-removable dispensing mechanisms. In some such embodiments, the lickable treats may be housed in multiple separate compartments and dispensed from a single semi-removable dispensing mechanism. In some embodiments, the device may include multiple separate compartments in which the lickable treats are housed and may include multiple semi-removable mechanisms from which these lickable treats might be dispensed. In some such embodiments, the device may include two or more semi-removable dispensing mechanisms from which to dispense lickable treats from the proximal end of the device. In other such embodiments, the device may essentially comprise two devices with the distal ends affixed to one another. In such embodiments, the device might generally be described as being ‘dual-ended’ and, for example, include semi-removable dispensing mechanisms located at both the proximal and the distal end of the device.

The device described in this disclosure may assume any number of physical dimensions. A preferred embodiment of the device may include space in which to house between 0.25 and 10 oz of the lickable treat, but other embodiments of the device may entail alternative volumetric capacity. Some preferred embodiments of the device may range from 0.5″ to 12″ in length, 0.5″ to 6″ in depth, and 0.5″ to 6″ in depth, but other embodiments may include alternative dimensions. Various embodiments of the device may assume any number of shapes. Some preferred embodiments of the device may generally assume a cylindrical shape. In some preferred embodiments of the device, the width of the device may exceed the depth of the device or the depth of the device may exceed the width of the device, generally giving the device a ‘flat’ shape. In general, preferred embodiments of the device will likely include dimensions and shapes that can be easily stored, transported, and used. Flat embodiments of the device, housing between 0.5 and 3 oz may be among the more preferred embodiments of the device, as such dimensions might enable users to easily store the device in pockets and comfortably fit the device in a single hand.

### EXAMPLE EMBODIMENTS OF THE ANIMAL TREAT DISPENSER AND TRAINING DEVICE FOR CONTROLLABLE DELIVERY OF LICKABLE TREAT

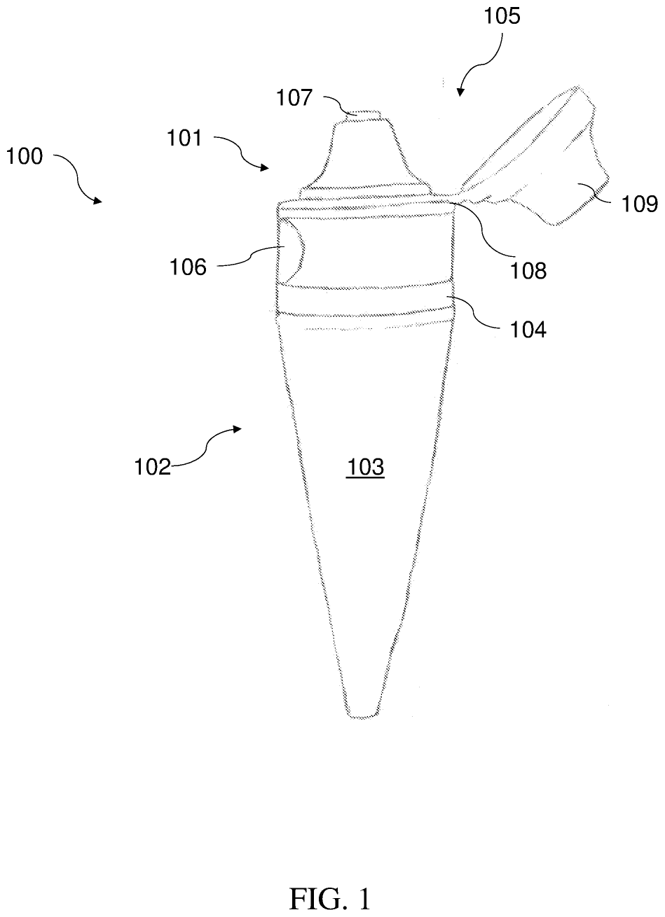

FIG. 1 illustrates a side-perspective view of a first example pet reward and training device 100. Pet reward and training device 100, which comprises a proximal component 101 and a distal component 102, might often be used as a device by which to distribute semi-solid treats (e.g., gels, pastes, creams), or other lickable treats that are pliable in nature. FIG. 1 provides a view of the device 100 in which the proximal component 101 and distal component 102 of the device 100 are securely interlocked; these two components of the device can also be disconnected.

The distal component 102 comprises a flexible or partially flexible housing 103 in which a lickable treat might be stored and from which a lickable treat might be extruded into the proximal component 101, from which the lickable treat might be dispensed. The flexible nature of the housing 103 in which the treat is stored and from which it is extruded to be dispensed allows the user to have control over the dispensing of semi-solid edible treats, as the user can change the rate of flow by, e.g., reducing the amount of pressure exerted on the housing 103 in order to lessen the treat flow or increasing the amount of pressure exerted on the housing 103 in order to increase the treat flow. The flexible or partially flexible housing 103 of the distal component 102 might be made of any material, including, for example, plastic or plastic polymers, aluminum, or silicone. The appearance of the flexible housing may take any form, including solid or opaque layers, transparent layers, graphic designs or pictures, or other visual appearances not specified here. Some preferred embodiments of the flexible or partially-flexible housing 103 might be made of a combination of materials or may be made of more than one layer of different types of materials. In some preferred embodiments of the device, the flexible or partially-flexible housing 103 may include or essentially consist of a material that provides some level of thermal insulation that may be used to help regulate the temperature of the edible treat enclosed therein. The distal component 102 in which the treat is housed may include additional features that are desirable for users or facilitate ease of use. Such additional features may potentially be affixed to the flexible housing 103, but they may be incorporated into the distal component of the device 102 in a variety of ways.

The distal component 102 seen in FIG. 1 includes an opening (not shown) through which semi-solid or pliable treats can freely move. When the proximal and distal components of the device are disconnected, this opening in the distal component 102 can be used as a means by which to load the flexible treat compartment 103 with pliable treats. When the proximal and distal components of the device are securely connected, the opening serves as a pathway through which the lickable treat housed in the flexible body 103 can be extruded into the distal component 101 and dispensed. In device 100, the opening is surrounded by a rigid circumference at the end of the distal component 104 to which the flexible housing 103 is securely attached. In this particular embodiment, the rigid proximal end of the distal component 104 is directly molded around the flexible housing of the distal component 103, thus securely and permanently attaching 103 and 104. This rigid proximal end of the distal component 104 provides a means by which to securely and releasably affix the distal component in which the edible treat is housed 102 and the proximal component 101 through which the treat is dispensed (note: the proximal component 101 through which the treat is dispensed may generally be referenced ‘the endcap’). In the embodiment of the device illustrated in FIG. 1, the endcap 101 is securely affixed to the rigid proximal end of the distal component 104 via threading located on the interior of the distal portion of the endcap 101 (not visible) and threading located on the exterior of the rigid proximal end of the distal component 104 (not visible) that can be screwed together to securely and releasably engage the proximal component 101 and the distal component 102 of the device. In other embodiments of the device, the endcap 101 might be affixed to the distal component 104 of the device via a number of other structures and mechanisms, such as magnets, buckle-style or press-release mechanisms, snap-fit components, or other structures or mechanisms (or combinations thereof) not specified here.

In this particular embodiment of the device, the endcap 101 includes a clicker device 106 that might be directly integrated into the design of the endcap 101. In some embodiments of the device, the location where the clicker device 106 is located might include other types of noisemakers (e.g., a squeaker) that might be used to attract and retain a pet's attention, other pet-related features, or storage compartments; some embodiments of the device may include no such features. The endcap 101 includes an opening 107 through which the lickable edible treat might be extruded from the device 100 and dispensed to an animal by squeezing, rolling, or otherwise manipulating the flexible body 103 in which the treat is housed. In this particular embodiment of the device, the opening 107 may be sealed or unsealed (or opened and shut, revealed and covered, exposed and concealed, etc.) by a lid 109 that is connected to the endcap 101 via a hinge 108. In this particular embodiment of the device, the opening 107, the lid 109, and the hinge 108 that essentially comprise the semi-removable dispensing mechanism 105 may generally be described as a ‘flip-top cap’ or a ‘flip-top lid’. In this particular embodiment of the device, the flip-top cap design is somewhat elongated, with the opening 107 through which the edible treat is dispensed extending in a conical shape and the lid 109 shaped to accommodate the elongated nature of the opening 107. Different embodiments of the device in which the semi-removable dispensing mechanism 105 is a flip-top cap, or some variation thereof, may take a variety of shapes and sizes.

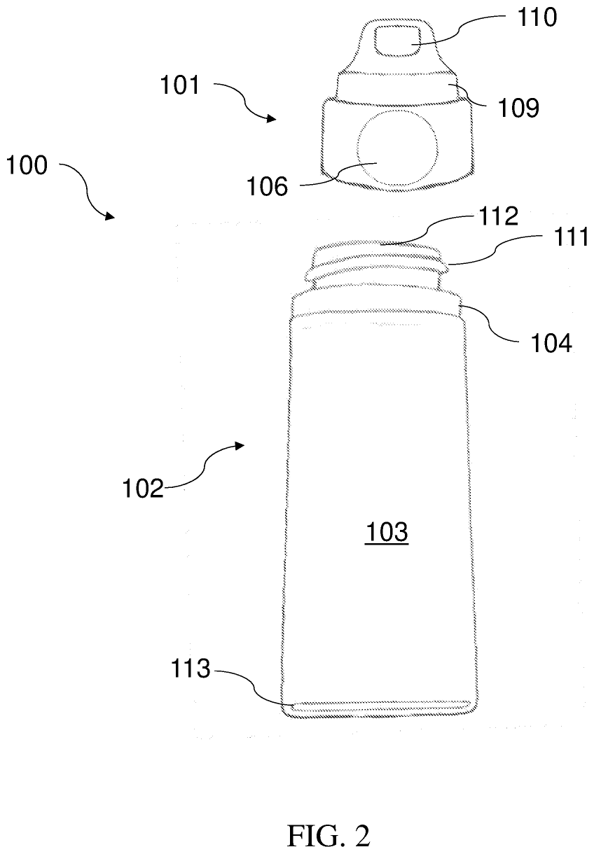

FIG. 2 illustrates an exploded front-perspective view of the first example pet reward and training device 100. This view of example device 100 illustrates features of this particular embodiment of the device that are not necessarily visible from FIG. 1. The endcap 101 depicted in FIG. 2 is closed, revealing an aspect of the lid 109 that was not visible in FIG. 1. In this particular embodiment, the lid 109 of the semi-removable dispensing mechanism 105 includes an indent 110 that might be used to help facilitate the ease with which the flip-top cap mechanism is operated. Given the elongated shape of the particular flip-top lid mechanism depicted in FIG. 1 and FIG. 2, this indent 110 may be particularly helpful in providing traction for, e.g., a thumb used to flip open the cap, thus supporting single-handed use of the device.

FIG. 2 illustrates the location of opening 112 at the proximal end of the distal component through which the pliable treat might be loaded or filled into the distal component of the device 102. This opening 112 was referenced in the description of FIG. 1 but was not visible in the side perspective of the device in which the proximal component 101 and the distal component 102 of the device were securely connected. FIG. 2 also illustrates the threading 111 in the rigid proximal end of the distal component 104 that was similarly referenced in the description of FIG. 1 but was not visible in that perspective. In this particular embodiment of the device, threading 111 might be used in conjunction with threading located inside the interior of the proximal component 101, thus ensuring a secure, air-tight fit, and releasable connection between the proximal 101 and distal 102 components of the device. Once the proximal and distal components of the device are connected, opening 112 provides a pathway through which the pliable treat can be advanced from the flexible housing 103 to the opening 107 through which it is dispensed to a pet.

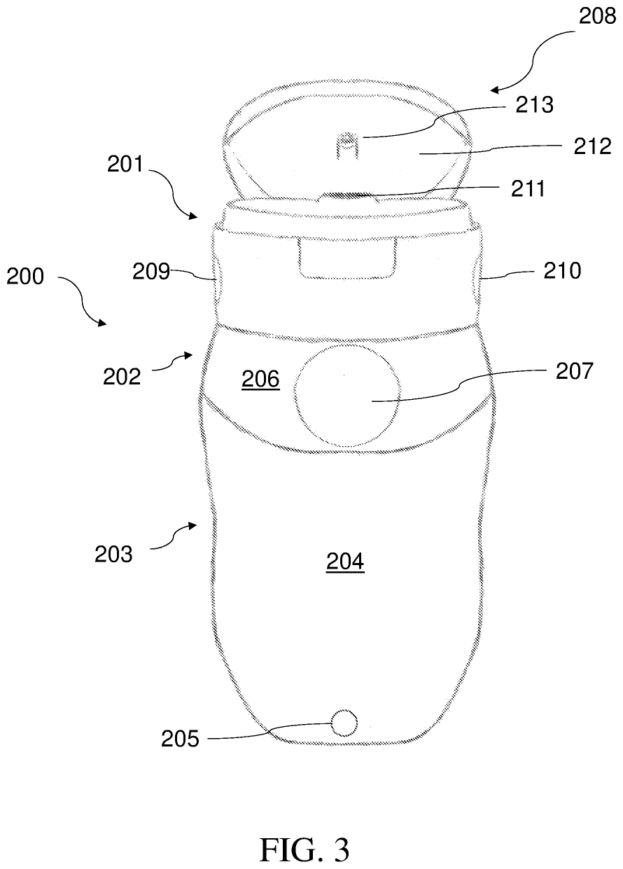

FIG. 3 provides a front view of a second example pet reward and training device 200. Pet reward and training device 200 comprises a proximal component 201, a distal component 203, and an auxiliary component 202 which serves to help attach the proximal 201 and distal 203 components. The proximal component 203 is essentially comprised of a flexible, semi-flexible, or partially-flexible body 204 in which a lickable treat (likely a semi-solid or pliable treat) might be stored and from which the lickable treat might be extruded and dispensed to a pet. Similar to the flexible material 103 in example device 100, the flexible material comprising the flexible body 204 in example device 200 might include thermally-insulating materials or layers and may contain some number of layers. In this particular embodiment of the device, the flexible housing 204 includes a hole or opening 205 extending through the flexible material (i.e., insulated from the edible treat stored in the flexible material 204) from the front of the device to the back of the device. The insulation between hole 205 and the edible treat housed in 204 might be made of a number of materials or combinations thereof, for example, it might primarily be comprised of the flexible material of 204 or it might primarily be comprised of a more rigid material (e.g., a plastic or a polymer). Holes or openings such as 205 might assume any number of shapes and sizes and might be made of any number of materials in different embodiments of the device.

In this particular embodiment of the device, the auxiliary component 202 used to help affix the flexible body 204 in which the edible treat is stored might be a shell that is slipped over a lip at the opening of the flexible body 204. In this particular embodiment, the auxiliary component 202 might essentially be comprised of a rigid or semi-rigid material 206 and include an opening 207 for a clicker device. In example device 200, the auxiliary component 202 might be affixed to the proximal component of the proximal component 201 via two ‘press-button’ or ‘buckle-style’ structures that extend through the holes 209 and 210 on either side of component 201. The semi-removable dispensing mechanism 208 of this device, which may generally be described as a ‘flip-top lid’ or a ‘flip-top cap’, includes an opening through which the lickable treat is dispensed from the device 211, a top lid 212, and a stopper 213 that may be used to plug opening 211 when the lid 212 is closed. The semi-removable dispensing mechanism 208 also includes a hinge that is not visible in this view of the device.

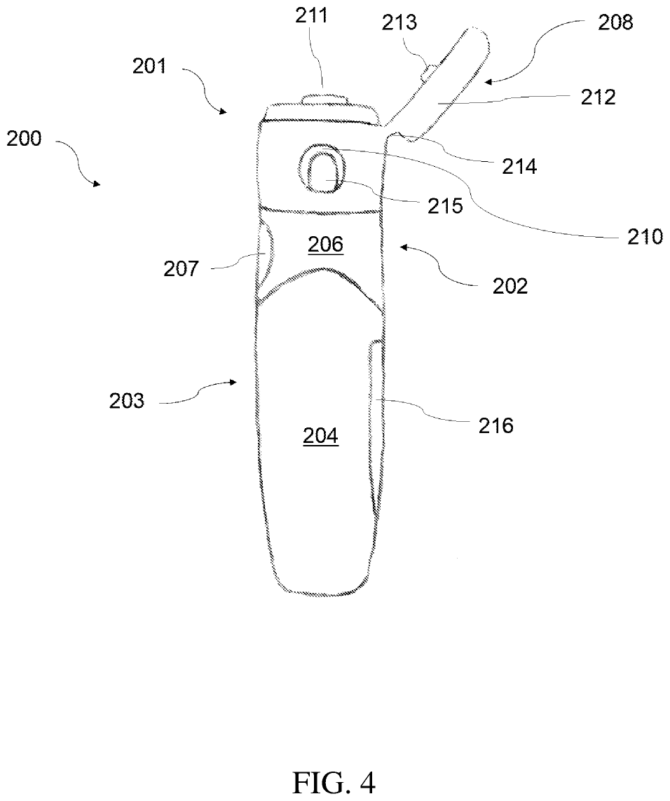

FIG. 4 provides a side-perspective view of the second example pet reward and training device 200. This view of example device 200 illustrates features of this particular embodiment of the device that are not necessarily visible from FIG. 3. In particular, the side-perspective view illustrates the ‘press-button’ or ‘buckle-style’ structures 215 of auxiliary component 202. This particular view of the device illustrates a single buckle-style structure 215 of component 202 that is secured (what might be colloquially described as ‘clipped in’ or ‘buckled in’) to the opening 210 in the proximal component 201 of the device. In device 200, a similar buckle-style structure might be found on the other side of the device (not visible in this view). In this particular embodiment of the device 200, the auxiliary component 202 may be slipped around the neck of the flexible body 204 and used to affix the distal component of the device 203 to the proximal end of the device 201 by pressing the two components together. The auxiliary component 202 and flexible body of the device 204 may be disconnected from the proximal end of the device 201 by pressing the buckle-style structures 215 in from the outside of the device, thus releasing the buckle-style mechanism.

FIG. 4 provides a view of the hinge 214 connecting the top lid of the device 212 to the main proximal component 201 of the device. In this particular embodiment of the device, the semi-removable dispensing mechanism of the device is primarily comprised of the opening 211 through which the lickable treat is dispensed, the top lid 212 and the stopper structure 213 used to seal the opening 211 when closed, and the hinge 214. In example device 200, the opening 211 is surrounded by a small rim, but the opening may take different forms in other embodiments of the device (e.g., the opening might be flush against the top of the cap, without any surrounding rim). FIG. 4 also illustrates additional features that might be included as part of the device, as the flexible body 204 includes a flexible pocket structure 216 on the back of the device that might be used for storage (e.g., storage of waste bags or keys).

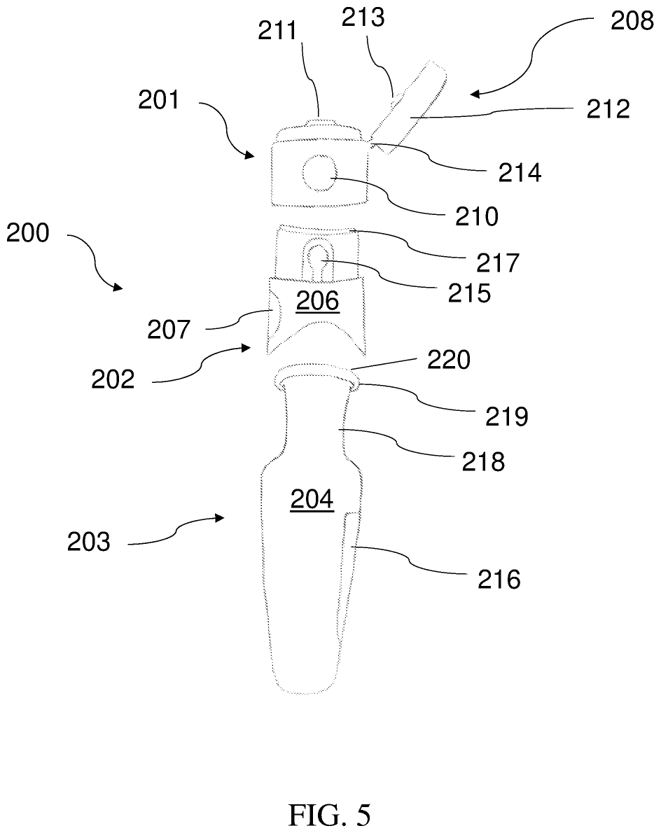

FIG. 5 provides an exploded side-perspective view of the second example pet reward and training device 200. This view of the device offers a complete view of the proximal component 201, the distal component 203, and the auxiliary component 202 used to help affix the flexible body 204 of the distal component 203 to the proximal component 201. The proximal component 201 clearly shows the openings 210 by which the ‘buckle-style’ structures 215 of the auxiliary component 202 are secured. As seen in FIG. 5, the flexible body 204 of the distal component 203 includes a relatively long and thin neck 208 that culminates in a flexible rim 219 with a greater circumference. Though not visible in this image, the flexible rim 219 encircles an opening 220 by which the flexible housing might be loaded with a lickable treat and through which the treat moves as it is extruded from the flexible housing 204 into the proximal component of the device 201 and dispensed through the opening 211. In this particular embodiment of the device, the flexible rim 220 of the distal component 201, is slipped over the rigid rim of the auxiliary component 217 to generally position the auxiliary component 202 around the flexible body 204. The flexible rim 220 may serve as a gasket when the auxiliary component 202 is secured to the proximal component of the device 201 and can help ensure an air-tight fit between the two components.

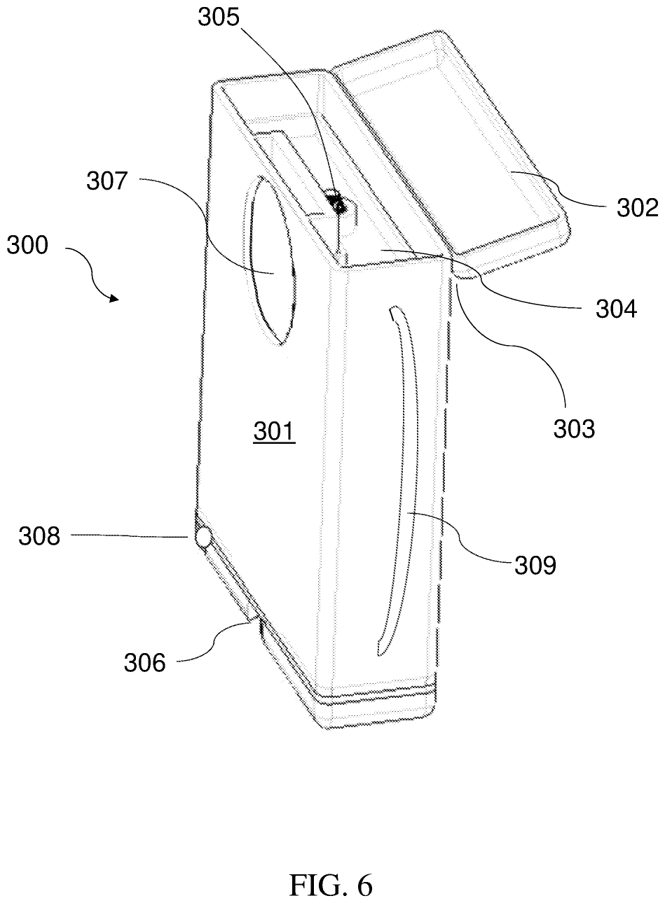

FIG. 6 provides an angled perspective of a third example pet reward and training device 300. In this particular embodiment of the device, the main body of the device largely consists of a rigid body 301 in which the lickable edible treat might be stored. This housing for the edible treat 301 may be made up of any variety of materials and may include multiple layers or a combination of different materials. In this device 300, the edible treat might be advanced from the storage compartment 301 to be dispensed to a pet by a mechanism embedded in the treat storage compartment 301. In this particular embodiment of the device, the treat advancement mechanism includes a threaded auger 305, a basket 304 in or on which the treat might be located and through which the threaded auger 305 extends, and a structure 306 which might be manipulated to rotate the auger 305 and advance the basket 304. In some embodiments of the device, the basket 304 might be designed so as to sit flush against the inner walls of the treat housing 301 in order to enable less-viscous treats to be advanced through the device. Other embodiments of the device might include, for example, a single, solid, lickable treat that might be balanced on the basket 304 and advanced through the treat storage compartment 301.

The proximal end of this device includes a semi-removable dispensing mechanism that might be generally described as a flip-top cap or a flip-top lid. In this particular embodiment of the device, a lid 302 is attached to the main body of the device 301 via hinge 303. The flip-top cap mechanism is designed so as to enable the user to open the cap with a single hand. In this particular embodiment of the device, the opening that is alternatively sealed and resealed by the flip-top cap mechanism essentially comprises the entire proximal end of the treat compartment 301. Other embodiments of the device may include other types of semi-removable treat dispensing mechanisms that may expose varying amounts of the lickable treat.

Other features of device 300 that are illustrated in FIG. 6 include a clicker device 307 embedded in the front of the device. In other embodiments of the device, this space might be used for alternative purposes, for example as a storage compartment for waste bags or keys, and may not be included in all embodiments of the device. FIG. 6 also includes a hole 308 which may be used, for example, to attach the device 300 to a waistband, a leash, a keychain, a retractable device, or other items. This embodiment of the device 300 also includes a strap 309 which might be wrapped around the user's hand to facilitate ease of storage and ease of use. In various embodiments of the device, a strap such as 309 or other such structures, might also be used to affix the device to other items (e.g., a leash), and may include mechanisms by which the length of the strap or other structure might be modified.

In example device 300, the width of the body 301 is significantly greater than its depth (i.e., the front view is wider than the side view); other embodiments may have different ratios between the two dimensions. This example device is relatively flat and wide; this may be a preferred embodiment for users who desire a treat-dispensing device that can be sleekly and discreetly stored (e.g., in a pocket). Other embodiments of the device may include different dimensions and different shapes (e.g., a cylindrical device similar in shape to a typical lip balm tube, among other potential embodiments).

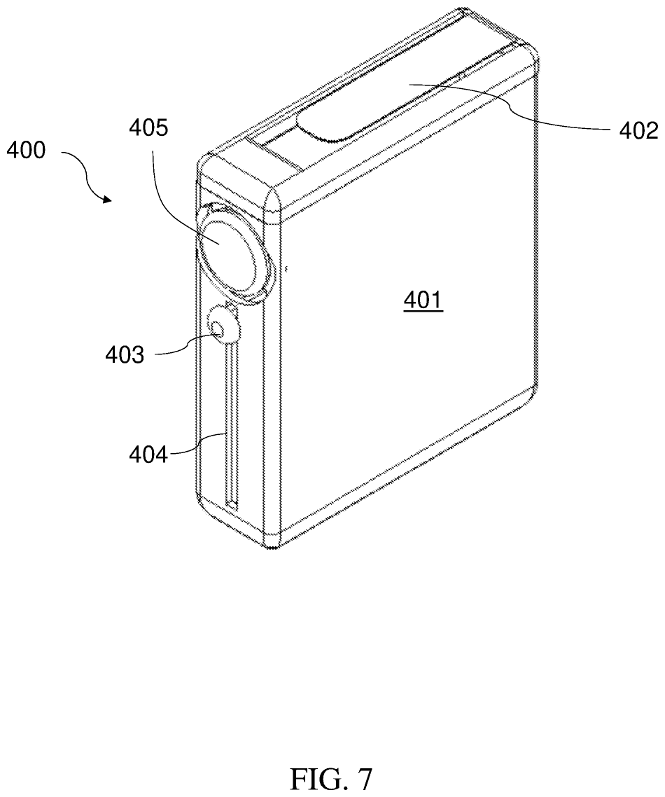

FIG. 7 provides an angled perspective of another example device 400. In this particular embodiment of the device, the main body of the device largely consists of a rigid body 401 in which the lickable edible treat might be stored. In this device 400, the edible treat might be advanced from the storage compartment 401 to be dispensed to a pet by utilizing a lever mechanism 403 that can be manipulated through the vertical opening in the device 404. In FIG. 7, the lever component 403 may be only one part of the overall lever mechanism. In many potential embodiments, lever-style treat advancement mechanisms may include additional parts that are not visible in FIG. 7. Different embodiments of the device may include treat advancement mechanisms that require different types of manipulation in order to advance the treats. For example, in some devices that include lever-type mechanisms, some preferred embodiments may require users to push the lever up towards the top of the device to advance the treat, whereas other preferred embodiments may require users to pull the lever down towards the bottom of the device to advance the treat, while other devices that include advancements via threaded augers may require the user to rotate the threaded auger to advance the lickable treat. In device 400, the semi-removable dispensing mechanism includes a retractable lid 402 that is connected to the lever component 403, enabling the user to open the retractable lid and advance the treat mechanism with a single hand. In other embodiments of the device, the semi-removable dispensing mechanism may take alternate forms, (e.g., a flip-top cap that may be opened either manually or automatically as part of the treat advancement mechanism).

FIG. 7 also includes a view of an additional feature that may be included in the device. In this particular embodiment, the additional feature may comprise a clicker 405, but this may be different in various embodiments of the design.

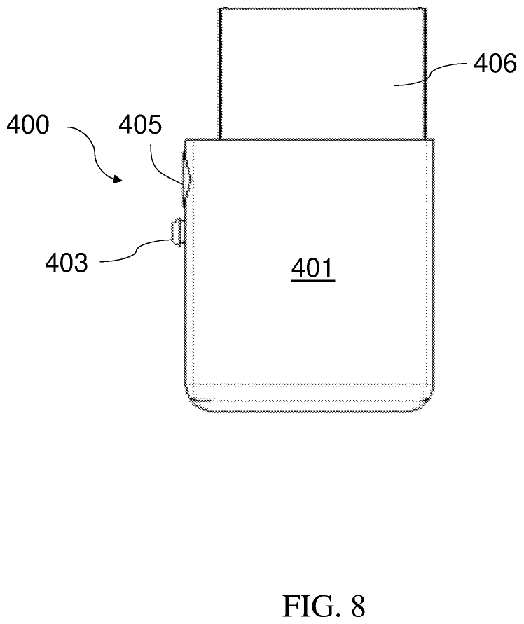

FIG. 8 provides a side profile view of device 400, illustrating a potential extension of the lever mechanism 403 that might be used to advance and dispense the lickable treat. In this particular embodiment of the device, the lever mechanism might be used to advance a solid treat 406 out of the main treat storage body 401. Other embodiments of the device might include alternative lever mechanisms, for example, a telescoping mechanism that could be used to extend the treat far beyond the proximal end of the device, thereby extending the distance from which the lickable treat might be dispensed. Other embodiments of the device might include an assortment of modifications that might be used to enhance the form or function. the range or ease of use, or the general desirability, attractiveness, or value of the device.

1. A pet training and reward device comprising:
a proximal and a distal end;
one or more compartments included in the distal end of the device in which edible, lickable treats might be housed and from which said treats might be extruded from the distal end to the proximal end of the device via physical manipulation of the compartment (e.g., squeezing or rolling);
one or more semi-removable dispensing mechanisms included in the proximal end of the device that may be sealed and unsealed, and through which said lickable treats may be dispensed.

2. The device of claim 1, wherein the device includes one or more sound-making pet accessories, such as a clicker device or a squeaker.

3. The device of claim 1, in which the device may comprise two or more components that might be securely and releasably interlocked to comprise said device.

4. The device of claim 1, in which both the compartment in which the treat is stored and the semi-removable dispensing mechanism are included in a single component.

5. The device of claim 1, wherein the device includes one or more structures by which the device might be connected or affixed to another item such as a keychain, lanyard, retractable key holder, etc.

6. The device of claim 1, wherein the device includes one or more structures that may be used for storage (e.g., structures such as a pocket, a netting, or elastic straps; or structures such as cavities or compartments) or includes one or more structures by which such storage fixtures might be affixed to the device.

7. The device of claim 1, wherein the device is modified to incorporate one or more pet-related accessories (e.g., a flashlight).

8. The device of claim 1, wherein the treat storage compartment comprises or partially comprises a temperature-insulating material.

9. The device of claim 1, wherein some portion of the treat storage compartment is enclosed by a rigid external layer.

10. A pet training and reward device comprising:
a proximal and a distal end;
one or more compartments included in the distal end of the device in which an edible, lickable treat might be housed;
one or more mechanisms facilitating the extrusion of said lickable treat might be extruded from the distal end to the proximal end of the device;
one or more semi-removable dispensing mechanisms included in the proximal end of the device that may be sealed and unsealed, and through which the lickable treat may be dispensed.

11. The device of claim 10, wherein the device includes one or more sound-making pet accessories, such as a clicker device or a squeaker.

12. The device of claim 10, wherein the device includes one or more structures by which the device might be connected or affixed to another item such as a keychain, lanyard, retractable key holder, etc.

13. The device of claim 10, wherein the device includes one or more structures that may be used for storage (e.g., structures such as a pocket, a netting, or elastic straps; or structures such as cavities or compartments) or includes one or more structures by which such storage fixtures might be affixed to the device.

14. The device of claim 10, wherein the device is modified to incorporate one or more pet-related accessories (e.g., a flashlight).

15. The device of claim 10, wherein the treat storage compartment comprises or partially comprises a temperature-insulating material.

16. A dual-ended pet training and reward device comprising:
one or more compartments in which edible, lickable treats might be housed;
one or more semi-removable dispensing mechanisms from which the edible, lickable treats might be dispensed from the proximal end of the device;
one or more semi-removable dispensing mechanisms from which the edible, lickable treats might be dispensed from the distal end of the device.
